(19) United States
(12) Patent Application Publication
(10) Pub. No.: US 2021/0406352 A1
(43) Pub. Date: Dec. 30, 2021

(54) SYSTEM AND METHOD FOR BIOMETRIC-BASED USER AUTHENTICATION

(71) Applicant: Bettina JANSSEN, Hamburg (DE)

(72) Inventor: Bettina JANSSEN, Hamburg (DE)

(21) Appl. No.: 17/356,932

(22) Filed: Jun. 24, 2021

Related U.S. Application Data
(60) Provisional application No. 63/043,462, filed on Jun. 24, 2020.

(51) Int. Cl. G06F 21/32; G06F 21/40; G06F 16/908; G06N 3/08

(52) U.S. Cl. CPC G06F 21/32; G06N 3/08; G06F 16/908; G06F 21/40

(57) ABSTRACT

A biometric-based personal authentication method for identifying or proving the identity of a user in integrated security systems to ensure authorized access by the user to information, payment systems, critical facilities, secured premises, and indoor areas, etc. Reducing the user authentication time by processing smaller amounts of biometric information is achieved through the digital authentication codes (DAC) obtained using artificial intelligence (AI) algorithms for various authentication objects, both when creating a database and when identifying a user, that forms a set of DAC parameters for each user common for biometric different objects of user authentication, and when authenticating a user, the set of user DAC parameters is compared with sets of DAC parameters from the database, in such a way that first only the DAC parameters obtained from comparing the user's DAC with the reference standard user's DAC and with the highest validity are taken into account.

### RELATED APPLICATION

The present application claims benefit of and priority to U.S. Provisional Patent Application No. 63/043,462, Filed Jun. 24, 2020, which is hereby incorporated herein in its entirety.

### FIELD

The present disclosure relates to a system and method for biometric-based user authentication.

### BACKGROUND

Known methods for biometric-based user authentication for identifying or proving the identity of a user in integrated security systems to ensure authorized access by the user to information, payment systems, critical facilities, secured premises and indoor areas, etc. comprise creating a biometric database and authenticating a user as such, wherein at least one (monomodal) or two or more (multimodal) biometric distinct features of user authentication are used for the database creation and user authentication.

### SUMMARY

According to an aspect herein there is provided a system and method for biometric-based user authentication, comprising creation of a users' biometric database and authenticating a user as such, wherein at least two biometric distinct features of user authentication, at this, when creating the user database, the biometric parameters of each of the selected authentication objects for each user are measured; the measured biometric parameters of each user are converted through artificial intelligence (AI) algorithms into the parameters of the user's digital authentication codes (DAC) entered into the user database, and while authenticating the user, their biometric parameters are measured, converted using artificial intelligence (AI) algorithms into the corresponding DAC parameters; they are compared with the corresponding DAC parameters from the database, and the results of the comparison are used to evaluate the authentication result which differs in that the geometric parameters obtained for various authentication objects using artificial intelligence (AI) algorithms are used to create the DAC of objects, both during the creation of the database and during the authentication of the user; a single set of DAC parameters for each user is created for biometric different authentication objects, and during the creation of the database using artificial intelligence (AI) algorithms, a virtual “reference standard” user DAC obtained according to the divine proportion principle (proportio divina)=the ratio of the object elements' size from large to small is the irrational golden number 1.6180339887, is created, and where its parameters meet these relevant requirements (the ratio of the size of the object elements from large to small is 1.6180339887); comparing the user DAC with the “reference standard” DAC, the significance of each of the user DAC parameters is determined in such a way that the greater significance corresponds to the user DAC parameters having a greater relative deviation from the corresponding “reference standard” DAC parameter, and when identifying the user, the set of user DAC parameters is compared with the sets of DAC parameters from the database, in such a way that firstly only the DAC parameters with the highest validity are taken into account, and with no coincidence within the established tolerance, it is concluded that there is no authentication; then, in the case of the initial coincidence of the DAC parameters with the highest validity, other DAC parameters with lower validity are sequentially analyzed in several steps, up to the values of the DAC parameters with the lowest validity, and if they coincide at the last stage, a conclusion is made about a positive authentication result.

In some cases, the system and method of biometric-based user authentication may use the hand geometry and the face geometry as biometrically different objects of user authentication.

In some cases, the system and method of biometric-based user authentication further including where, when identifying a user, the set of the user's DAC parameters is compared with the sets of DAC parameters from the database, in such a way that they are taken into account first only the DAC parameters obtained from comparing the user's DAC with the reference standard user's DAC in such a way that first only no more than three DAC parameters with the highest validity are taken into account, and only then the other parameters, but not more than three DAC parameters with lower validity, up to the analysis of the values of the DAC parameters with the lowest validity.

### DETAILED DESCRIPTION

The invention relates to a multimodal biometric-based personal authentication method. The user database creation includes measuring the biometric parameters of each selected authentication feature of each user, converting the measured biometric parameters of each user into the parameters of the user's digital authentication codes (DAC) to be included into the users database and authentication of a user includes measuring the user's biometric parameters, converting the latter into the corresponding DAC parameters, comparing them against the respective DAC parameters from the database, and, based on the comparison results, judging about the authentication result (ref. to U.S. Pat. No. 7,106,902, IPC G 06 K 9/62, published in 2003). The disadvantages of the known methods may include time intensiveness of the user authentication due to a large amount of biometric information to be processed, specifically at the step of comparing the user's DAC parameters determined during the user authentication against the respective DAC parameters from the database.

The closest in technical essence to the proposed method is a method for biometric-based user authentication, comprising creation of a users' biometric database and authenticating a user as such, wherein at least two biometric distinct features of user authentication are used for the database creation and user authentication, the user database creation includes measuring the biometric parameters of each selected authentication feature of each user, converting the measured biometric parameters of each user into the parameters of the user's two digital authentication codes (DAC) to be included into the users database, and authentication of a user includes measuring the user's biometric parameters, converting the latter into the corresponding DAC parameters, comparing them against the respective DAC parameters from the database, and, based on the comparison results, judging about the authentication result (ref. to RF U.S. Pat. No. 2,406,143, IPC G 06 K 9/03, published in 2010). The disadvantages of the known method may also include time intensiveness of the user authentication due to a large amount of biometric information to be processed, specifically at the step of comparing the user's DAC parameters determined during the user authentication against the respective DAC parameters from the database.

Through the use of artificial intelligence technology (AI) the proposed method aims to solve the problem and achieve a technical result consisting of
a) reducing the time spent on user authentication
b) preventing from a high noise and ensuring interference immunity
c) adapting to environmental changes (for example luminosity variation).

This technical result is achieved by the method for biometric-based user authentication, including creating a user biometric database and authenticating a user as such, where at least two biometric different objects of user authentication are used during the creation of the database and authentication, while at the time of creating the user database the biometric parameters for each of the selected user authentication objects are measured, converted by using artificial intelligence (AI) algorithms into the parameters of its digital authentication codes (DAC), which are entered into the user database, and when authenticating the user the object is scanned and the information is sent to the input of the neural network obtaining the DAC parameters at its output that are compared with the corresponding DAC parameters from the database and the comparison results are used to judge the authentication result based on the DAC obtained for various authentication objects.

Both when creating the database and identifying a user, a single set of the DAC parameters for each user is created for biometric different objects of authentication, and when the database is created, the user DAC is compared with the “reference standard” DAC obtained upon processing the “virtual” (artificially created) object built according to the divine proportion principle (latin: proportio divina)—also called: the golden ratio, golden mean, golden section (latin: sectio aurea), golden proportion, golden cut or golden number. The “virtual” object's DAC serves as a “reference standard” when determining the significance of each DAC parameter of the studied object in such a way that the greater significance (the weight of each parameter) corresponds to the DAC parameter having a greater relative deviation from the corresponding DAC parameter of the “reference standard” object, and when authenticating the user, the set of parameters of the user's DAC is compared with the sets of the DAC parameters from the database in such a way that firstly only the DAC parameters that have the greatest significance are taken into account, and in the absence of their coincidence within the established tolerance, it is concluded that there is no authentication; then, in the case of initial coincidence of the DAC parameters with the highest validity, other DAC parameters with a lower validity are analyzed sequentially in several steps up to the analysis of the values of the DAC parameters with the lowest validity, and if they coincide at the latter stage, a conclusion is made about a positive authentication result.

Therein, it is advantageous to use, as the biometrically distinct user authentication features, the hand geometry and face geometry, and, when authenticating a user, to compare a set of user DAC parameters against the sets of DAC parameters from the database such as to first consider a maximum of three DAC parameters with the highest validity and then other, but a maximum of three, DAC parameters with a lower validity, up to the values of the DAC parameters with the lowest validity.

Creating for each user a set of DAC parameters common for biometrically different user authentication objects, with the use of artificial intelligence (AI) technologies based on the DAC obtained for various authentication objects, both during the creation of the database and during the authentication of the user, makes it possible to use a particular combined biometric object or a whole collected from several separate biometric objects for conceptual authentication, based on which a comparison of the user's DAC and DAC from the database is carried out.

Therein, comparing a single set of the user DAC parameters with 4 similar single sets of the DAC parameters from the database is less time intensive than comparing each user DAC for each feature with each DAC of each feature from the database.

Creating a database using a “virtual” object DAC obtained according to the divine proportion principle (proportio divina) the parameters of which meet the relevant requirements (the ratio of the object elements' size from large to small is the irrational golden number 1.6180339887), followed by the determination of the significance or weight of each of the DAC parameters, allows revealing, in essence, the “rating” of the DAC parameters for the population of users to be authenticated, according to the degree of their dominance related to distinctive biometric features from the “reference standard” user.

The fact that authenticating a user includes comparing a set of user DAC parameters against the sets of DAC parameters from the database, such that first only the DAC parameters with the highest validity are considered, makes it possible to discard, straight after such “partial” authentication, and, as is proved by experience, to avoid further comparative analysis for about 90% of the users, for whom no match has been initially found for the DAC parameters with the highest validity. Therein, the overall time consumed for user authentication is reduced through comparing, at the first step, of the users' DAC parameters from the database against a set of an individual user's DAC parameters not with respect to the whole set of parameters included in the DAC, but only with respect to certain number of parameters, and through the possibility to consider, at the next step of comparison, the sets of DAC parameters from the database corresponding not to all the users, but, for example, to only the remaining 10% of the users and so on at the subsequent steps with respect to each time smaller number of the users. The reason for considering, when authenticating a user, first a maximum of three DAC parameters with the highest validity and then the other, but up to a maximum of three, DAC parameters with a lower validity, is that a smaller number of the DAC parameters would require a larger number of authentication steps, and the larger number of DAC parameters would require more time to perform each step of comparison. With regard to the optimum overall time consumption, our studies have demonstrated that the most advantageous is to use, at each step, a maximum of three, such as two or three, DAC parameters with the highest validity. An example embodiment of the present method for biometric-based user authentication is described below. Let's assume that a biometric-based user authentication in an integrated security system has to be done with respect to 1000 users. Therein, the biometrically distinct user authentication features to be used are the hand geometry and the face geometry. According to the conventional state-of-the-art biometric-based authentication methods (ref. to State-of-the-Art Biometric-Based Authentication Methods. Internet, website https://habrahabr.ru/post/126144), each of the above biometric features is characterized by the respective biometric parameters; for example, the hand geometry is characterized by the finger length, hand width, etc., while the face geometry is characterized by the face widths at various levels, inter-eye distance, mouth to chin distance, etc. In our opinion, there are 128 most meaningful parameters as part of the hand geometry biometric feature and 128 biometric parameters as part of the face geometry biometric feature.

A user database including the DAC of each user is created preliminarily. At the same time, geometric characteristics of the object are measured and sent for processing to artificial intelligence (AI), and 128 biometric parameters of each user for each biometric object are obtained at the output, and these measured biometric parameters are converted into this user's DAC parameters. Each user's DAC is represented as a single set of DAC parameters for biometric different objects of user authentication, for example, as shown below, where the numbers in the upper row are the conditional numbers of each parameter, and the numbers in the lower row are the values of the corresponding parameters, for example, in centimeters, millimeters or in any given units which are the same for all parameters.

| 1 | 2 | 3 | [symbol] | 126 | 127 | 128 |
|---|---|---|---|---|---|---|
| 10 | 5 | 23 | [symbol] | 15 | 20 | 30 |

[symbol]

indicates data missing or illegible when filed

Thus, the database contains 1000 DACs for each user in a form similar to the DAC above.

Next, the “reference standard” user DAC is created for each biometric user object; namely, information corresponding to the virtual object (obtained as a result of mathematical calculations) that meets the requirements of the divine proportion principle is fed to the input of the neural network (an element of artificial intelligence (AI)).

| 1 | 2 | 3 | [symbol] | 126 | 127 | 128 |
|---|---|---|---|---|---|---|
| 9 | 3 | 27 | [symbol] | 10 | 25 | 40 |

[symbol]

indicates data missing or illegible when filed

Then, using each user DAC and the “reference standard” user DAC, each of the DAC parameters' significance is determined so that the greater significance corresponds to the DAC parameter having a more significant relative deviation from the corresponding DAC parameter of the “reference” user. Using the example of the above-presented individual user DAC and the “reference standard” user DAC, it is possible to show the result of calculating the relative deviations of each DAC parameter.

| 1 | 2 | 3 | [symbol] | 126 | 127 | 128 |
|---|---|---|---|---|---|---|
| 1.11 | 0.6 | 0.85 | [symbol] | 1.5 | 0.8 | 0.75 |

[symbol]

indicates data missing or illegible when filed

In this way, we have obtained 1000 “reference standard” DAC of each user, composed in the values of relative deviations of each parameter. Assuming that the above relative deviations of the parameters correspond to those maximum possible for all the users or correspond to the validity of each parameter, then the maximum validity among those with the highest validity have three DAC parameters numbered 126, 2, 128. In a similar way, we determine the next three DAC parameters with the highest validity, but their validity is lower relative to the DAC parameters numbered 126, 2, 128, and so on.

A user authentication is then performed, and a set of user DAC parameters is compared against the sets of DAC parameters from the database, such that first only the DAC parameters with the highest validity, i.e. those numbered 126, 2, 128, are considered. In the depicted example, there is no match for them within the established tolerance (the tolerable match is typically considered to be at least 95%) for 87% of the total number of users, and, as is evident, a negative authentication is inferred with respect to such users, so their DAC will not be considered at all in subsequent comparative analysis of DAC. Only the remaining 13% of the users for whom there are matches with the DAC parameters numbered 126, 2, 128 undergo further comparative analysis with respect to only three DAC parameters with the highest validity, but with a lower validity relative to the DAC parameters numbered 126, 2, 128. In this example, these are the DAC parameters numbered 1, 3, 127. However, there are no matches within the established tolerance for 7% of the total number of users, and, as is evident, a negative authentication is inferred with respect to such users, so their DAC will not be considered at all in subsequent comparative analysis of DAC. In this way, only 6% of the total number of users remains for further comparative analysis. The other DAC parameters are then sequentially analyzed in a way, similar to the described above, in several steps, the parameters having each time less validity, up to the values of the DAC parameters with the lowest validity, and, if there is a match at the last step, a positive authentication is inferred. As is obvious, if there is not match even at the last step of comparison, a negative authentication will be inferred. The above described method has been implemented in a test mode in integrated security systems with respect to 80,000 and 550,000 users, and the time consumed for authentication in those systems was 1 to 2.5 seconds. The time consumed for authentication, where a conventional method including full comparison of the user DAC against those of each user from the database was used, amounted up to 5 seconds.

The present methods provides reducing the time consumed for user authentication through the possibility to process a smaller amount of biometric information, specifically at the step of comparing the user DAC, determined during the user authentication, against the respective DAC parameters from the database.

Using the artificial intelligence (AI) algorithms (neural networks) for processing the characteristics of biometric objects while creating a DAC provides a significant noise and interference immunity towards the quality of parameters and ensures the adaptation of the DAC creating processes to changes in the illumination of objects.

When creating a DAC, information about the biometric object being scanned enters the first layer of the neural network, which is organized according to the modified Inception architecture with the basic combination of filters V1 and V3; information from the first layer goes to the group of convolutional layers and ends with a classification layer, at the output of which the object DAC is created.

The process features no photographs or images of biometric objects to ensure protection from falsification.

The neural network training process is organized based on the generated virtual objects database. Virtual objects were obtained using algorithms for decomposing an arbitrary table function into Gaussians; the creation process is based on the constructed virtual “reference” object. The virtual object creation is carried out by a special process setting the characteristics of the “reference standard” object and statistical deviations calculated by analyzing the geometric characteristics of authentication objects (the actual database contains the characteristics of 500 users' objects). The process of training a neural network is performed using a virtual objects database; the Deep Learning method is used: the “virtual” authentication objects with the expected DAC result are fed to the network input, and the goal of the process is to select the layers coefficients so that the result produced by the neural network coincides with the given one.

The coefficients and filters obtained as a result of training are used on the working neural network to register objects and identify users to form the DAC.

In general, the present disclosure relates to a biometric-based personal authentication system and method for identifying or proving the identity of a user in integrated security systems to ensure authorized access by the user to information, payment systems, critical facilities, secured premises, and indoor areas, etc. Reducing the user authentication time by processing smaller amounts of biometric information is achieved through the digital authentication codes (DAC) obtained using artificial intelligence (AI) algorithms for various authentication objects, both when creating a database and when identifying a user, that forms a set of DAC parameters for each user common for biometric different objects of user authentication, and when authenticating a user, the set of user DAC parameters is compared with sets of DAC parameters from the database, in such a way that first only the DAC parameters obtained from comparing the user's DAC with the reference standard user's DAC and with the highest validity are taken into account. At the same time, first, no more than three DAC parameters with the highest validity are taken into account, and only then the other parameters, but not more than three DAC parameters with lower validity, up to the analysis of the values of the DAC parameters with the lowest validity. By the use of artificial intelligence (AI) algorithms, a high level of noise and interference immunity (e.g. against a different color of the object, change in position during scanning) and the ability to adapt to changes in the environment, e.g. the influence of external light sources, is achieved.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether the embodiments or elements thereof described herein are implemented as a software routine, hardware circuit, firmware, or a combination thereof.

Embodiments of the disclosure or elements thereof may be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

1. A method for biometric-based user authentication, comprising creation of a users' biometric database and authenticating a user as such, wherein at least two biometric distinct features of user authentication, at this, when creating the user database, the biometric parameters of each of the selected authentication objects for each user are measured; the measured biometric parameters of each user are converted through artificial intelligence (AI) algorithms into the parameters of the user's digital authentication codes (DAC) entered into the user database, and while authenticating the user, their biometric parameters are measured, converted using artificial intelligence (AI) algorithms into the corresponding DAC parameters; they are compared with the corresponding DAC parameters from the database, and the results of the comparison are used to evaluate the authentication result which differs in that the geometric parameters obtained for various authentication objects using artificial intelligence (AI) algorithms are used to create the DAC of objects, both during the creation of the database and during the authentication of the user; a single set of DAC parameters for each user is created for biometric different authentication objects, and during the creation of the database using artificial intelligence (AI) algorithms, a virtual “reference standard” user DAC obtained according to the divine proportion principle (proportio divina)=the ratio of the object elements' size from large to small is the irrational golden number 1.6180339887, is created, and where its parameters meet these relevant requirements (the ratio of the size of the object elements from large to small is 1.6180339887); comparing the user DAC with the “reference standard” DAC, the significance of each of the user DAC parameters is determined in such a way that the greater significance corresponds to the user DAC parameters having a greater relative deviation from the corresponding “reference standard” DAC parameter, and when identifying the user, the set of user DAC parameters is compared with the sets of DAC parameters from the database, in such a way that firstly only the DAC parameters with the highest validity are taken into account, and with no coincidence within the established tolerance, it is concluded that there is no authentication; then, in the case of the initial coincidence of the DAC parameters with the highest validity, other DAC parameters with lower validity are sequentially analyzed in several steps, up to the values of the DAC parameters with the lowest validity, and if they coincide at the last stage, a conclusion is made about a positive authentication result.

2. The method of biometric-based user authentication according to claim 1 where the hand geometry and the face geometry are used as biometrically different objects of user authentication.

3. The method of biometric-based user authentication according to claim 1 where, when identifying a user, the set of the user's DAC parameters is compared with the sets of DAC parameters from the database, in such a way that they are taken into account first only the DAC parameters obtained from comparing the user's DAC with the reference standard user's DAC in such a way that first only no more than three DAC parameters with the highest validity are taken into account, and only then the other parameters, but not more than three DAC parameters with lower validity, up to the analysis of the values of the DAC parameters with the lowest validity.
